(19) United States
(12) Patent Application Publication
(10) Pub. No.: US 2020/0055155 A1
(43) Pub. Date: Feb. 20, 2020

(54) Automatic cooling and steel cutting equipment

(71) Applicant: Liying Mao, Taizhou City (CN)

(72) Inventor: Liying Mao, Taizhou City (CN)

(21) Appl. No.: 16/663,371

(22) Filed: Oct. 25, 2019

(30) Foreign Application Priority Data
Aug. 16, 2019 (CN) 2019107581357

(51) Int. Cl. B23Q 11/10; B23D 35/00; B23D 33/02

(52) U.S. Cl. CPC B23Q 11/10; B23D 33/02; B23D 35/001

(57) ABSTRACT

The invention discloses an automatic cooling and steel cutting device, which includes a casing, wherein the right end of the casing is provided with a conveying cavity, a connecting cavity and a driving cavity, the conveying cavity is provided with a conveying mechanism for pushing steel for cutting and the opening is upward, the connecting cavity is provided with a lifting mechanism for lifting the cutting part, the lower side of the connecting cavity is provided with a cutting mechanism for cutting steel. The device can cut off the steel evenly by itself when it is in use. During the cutting process, it will automatically spray water to cool down the steel and the cutter, so as to reduce the damage. After each section is cut, the cutter will automatically lift up to prepare the next section of steel cutting of wood.

### CROSS-REFERENCES TO RELATED APPLICATIONS

The present application claims priority from Chinese application No. 2019107581357 filed on Aug. 16, 2019 which is hereby incorporated by reference in its entirety.

### TECHNICAL FIELD

The present invention relates to the field of steel cutting, in particular to an automatic cooling and steel cutting equipment.

### BACKGROUND OF THE INVENTION

Steel can be said to be an essential building material, which can be seen everywhere in life. When using steel, it is often necessary to cut it to meet the size requirements of different building specifications; at present, when cutting steel, a lot of heat will be generated, which will make the surface of cutting tools and steel rapidly warm up. No matter for cutting tools or steel, it will cause certain damage.

### BRIEF SUMMARY OF THE INVENTION

The technical problem to be solved by the invention is to provide an automatic cooling and steel cutting device, to overcome the problems of uneven cutting of steel and non automatic cooling, and to realize the uniform cutting of steel and the automatic cooling function.

The invention is realized by the following technical scheme.

The invention relates to an automatic cooling and steel cutting equipment, which comprises a casing, wherein the right end of the casing is provided with a conveying cavity, a connecting cavity and a driving cavity, the conveying cavity is provided with a conveying mechanism for pushing steel for cutting and the opening is upward, the connecting cavity is provided with a lifting mechanism for raising and lowering the cutting part, the lower side of the connecting cavity is provided with a cutting mechanism for cutting steel, and the driving cavity A transmission mechanism is provided to provide power for the device, and the right side of the conveying cavity is provided with a cooling mechanism to cool down when cutting steel.

The lifting mechanism comprises a worm which is rotationally connected with the right cavity wall of the transmission cavity and the left cavity wall of the connection cavity, the left end key of the right end of the worm is connected with a moving gear, the moving gear is provided with a moving cavity with an opening to the right, the moving cavity is provided with a moving block which can slide in the cavity, the right end surface of the moving block is connected with a chain, the left end of the worm is provided with a ring plate, and the right end surface of the moving block is connected with a chain. The right end face of the annular plate is fixedly connected with a return spring, the right end of the return spring is connected with the mobile gear, the left and right cavity walls at the upper end of the connection cavity are rotationally connected with a rotating shaft, the left end of the rotating shaft is provided with a connecting gear, the right end of the rotating shaft is provided with a rotating gear, the upper and lower cavity walls at the right end of the connection cavity are rotationally connected with a rack, and the upper end of the rack is provided with a stop outside the device Plate, the lower end of the baffle plate is provided with two expansion springs, the lower end of the expansion spring is connected with the upper end of the shell, the lower end of the rack is connected with a lifting platform outside the device, the lifting platform is provided with a cutting cavity, the lower end of the shell is provided with a discharging port for dropping the cut steel out of the device, the left end wall of the shell is provided with a feeding port for putting the steel to be cut into the device The left and right cavity walls of the feed inlet are rotationally connected with a fixed rod which is provided with a feed baffle plate;

The steel is pushed to the right through the conveying mechanism, and then it is lowered by the cutting mechanism through the lifting mechanism to cut the steel evenly. During the cutting process, the temperature at the time of cutting is lowered by the cooling mechanism, and finally the steel after cutting is automatically dropped into the discharge port.

Further, the drive mechanism includes a motor fixed on the lower cavity wall of the drive cavity, the upper end of the motor is connected with a drive shaft, the lower end of the drive shaft is provided with a first bevel gear, the upper end of the drive shaft is provided with a drive sprocket, the drive sprocket is provided with a chain, the upper end of the drive shaft is also provided with a turbine on the upper side of the drive sprocket, and the right side of the drive cavity is provided with a There is a driven cavity, the left cavity wall of the driven cavity is rotationally connected with a driven shaft extending into the drive cavity, the left end of the driven shaft is provided with a driving pulley, the driving pulley is provided with a belt, the right end of the driven shaft is provided with a second bevel gear meshed and connected with the first bevel gear.

Further, the cutting mechanism comprises a rotating rod connected to the wall of the upper cavity of the cutting chamber, the upper end of the rotating rod is provided with a sliding gear, the sliding gear is provided with a sliding cavity with an opening upward, the sliding cavity is provided with a sliding gear which can slide in the cavity, the upper end of the sliding block is fixedly connected with a fixed rod, and the upper end of the fixed rod is fixedly connected with the outer wall of the housing. The sliding gear is connected with the chain, the lower end of the rotating rod is provided with a third bevel gear, the left and right walls of the cutting cavity are connected with a rotating shaft, the left end of the rotating shaft is provided with a fourth bevel gear, and the right end of the rotating shaft is provided with a cutting knife.

Further, the conveying mechanism includes rotating a screw rod connected to the left and right cavity walls of the conveying cavity, the left end of the screw rod is provided with a driven pulley, the driven pulley is connected with the belt, the left end of the screw rod is also provided with a threaded sleeve on the right side of the driven pulley, the upper side of the conveying cavity is provided with a pushing cavity with an opening to the right, and the upper end of the threaded sleeve is fixedly connected with a connection Connecting block, the upper end of the connecting block is provided with a push plate located in the push cavity, the right cavity wall of the discharge port is provided with a push block cavity with an opening to the left, the push block cavity is provided with a push block cavity which can move left and right in the cavity, the right end surface of the push block cavity is fixedly connected with a shrinkage spring, the right end of the shrinkage spring is connected with the right cavity wall of the push block cavity, and the lower end of the shrinkage spring is connected with a lock Chain.

Further, the cooling mechanism includes a water pipe on the upper side of the push block chamber, the water pipe is provided with a switch chamber, the switch chamber is provided with a mobile switch for switching water source, the lower end face of the mobile switch is fixedly connected with an elastic spring, the lower end of the elastic spring is connected with the lower wall of the switch chamber, and the upper end face of the mobile switch is fixedly connected with a top extending into the external space rod

Further, the elastic force of the expansion spring is greater than the sum of the weight of the lifting platform and the lifting platform components.

Furthermore, the spring force of the return spring is greater than the friction force received by the moving gear sliding on the worm.

Further, when the connecting block pushes the steel to the rightmost side to stop moving, the driving pulley will slip and stop rotating on the driven shaft.

Further, when the pushing block cavity moves to the right, pulling the chain can make the moving gear move to the right and mesh with the connecting gear.

The device has the advantages of simple structure and convenient operation. When the device is used, the steel can be cut off evenly by itself. In the cutting process, the water will be sprayed automatically to cool down the steel and the cutting tool, so as to reduce the damage. After each section is cut, the cutting tool will automatically lift up to prepare for the cutting of the next section of steel.

### BRIEF DESCRIPTION OF THE DRAWINGS

In order to explain the embodiments of the invention or the technical solutions in the prior art more clearly, the following will give a brief introduction to the drawings needed in the embodiments or the prior art description. It is obvious that the drawings in the following description are only some embodiments of the invention. For ordinary technicians in the skill field, they can also use these drawings without paying creative labor. Other figures are obtained from the figures.

FIG. 1 is the overall schematic structural diagram of the invention;

FIG. 2 is the right view structure diagram of A-A full section in FIG. 1 of the embodiment of the invention;

FIG. 3 is the structural diagram of position B in FIG. 1 of the embodiment of the invention;

FIG. 4 is the structure diagram of point C in FIG. 1 of the embodiment of the invention.

### DETAILED DESCRIPTION OF THE INVENTION

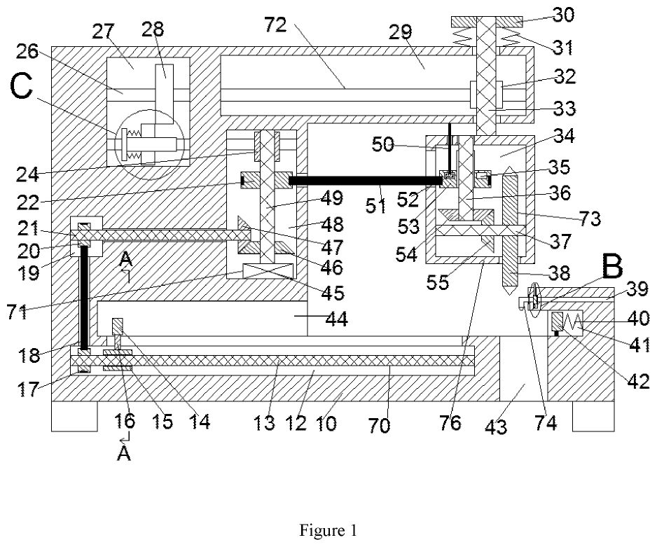

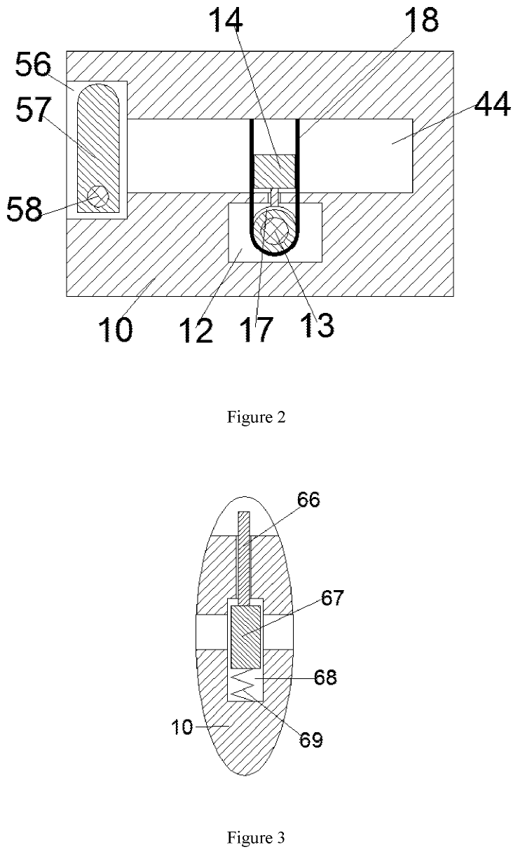

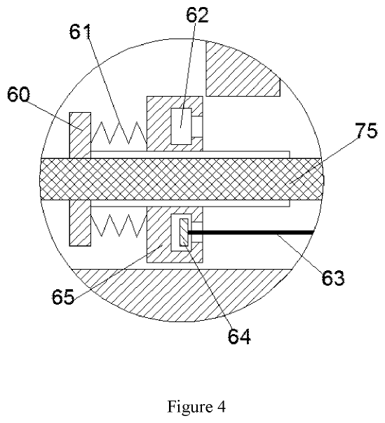

An automatic cooling and steel cutting equipment described in FIG. 1-4, including a casing 10, wherein the right end of the casing 10 is provided with a conveying cavity 12, a connecting cavity 27 and a transmission cavity 48, wherein the conveying cavity 12 is provided with a conveying mechanism 70 for pushing steel for cutting and opening upward, the connecting cavity 27 is provided with a lifting mechanism 72 for lifting the cutting part, and the lower side of the connecting cavity 27 is provided with a cutting steel The driving cavity 48 is provided with a driving mechanism 71 to provide power for the device, and the right side of the conveying cavity 12 is provided with a cooling mechanism 74 to reduce the temperature when cutting steel. The lifting mechanism 72 includes a worm 75 which is rotationally connected to the right cavity wall of the driving cavity 48 and the left cavity wall of the connecting cavity 27. The left end key of the right end of the worm 75 is connected with a moving gear 65, which is internally provided with A moving cavity 62 having an opening to the right is provided with a moving block 64 which can slide in the cavity, the right end face of the moving block 64 is connected with a chain 63, the left end of the worm 75 is provided with an annular plate 60, the right end face of the annular plate 60 is fixedly connected with a return spring 61, the right end of the return spring 61 is connected with the moving gear 65, and the left and right cavity walls of the upper end of the connecting cavity 27 are rotationally connected with a rotation A moving shaft 26, the left end of the rotating shaft 26 is provided with a connecting gear 28, the right end of the rotating shaft 26 is provided with a rotating gear 32, the right end of the connecting cavity 27 is provided with a rack 33, the upper end of the rack 33 is provided with a baffle 30 outside the device, the lower end of the baffle 30 is provided with two expansion springs 31, the lower end of the expansion spring 31 is connected with the upper end of the housing 10, and the lower end of the rack 33 The end is connected with a lifting platform 76 which is located outside the device, the lifting platform 76 is provided with a cutting cavity 34, the lower end of the casing 10 is provided with an outlet 43 for dropping the cut steel out of the device, the left end wall of the casing 10 is provided with a feed inlet 56 for putting the steel to be cut into the device, the left and right cavity walls of the feed inlet 56 are rotationally connected with a fixed rod 58, the fixed rod 58 is provided with a feed baffle 57, and the steel The steel is pushed to the right through the conveying mechanism 70, and then lowered by the cutting mechanism 73 through the lifting mechanism 72 to cut the steel evenly. During the cutting process, the temperature at the time of cutting is reduced through the cooling mechanism 74, and the steel finally cut automatically falls into the discharge port 43.

Advantageously, the drive mechanism 71 includes a motor 45 fixed on the lower cavity wall of the drive cavity 48, the upper end of the motor 45 is powerfully connected with a drive shaft 49, the lower end of the drive shaft 49 is provided with a first bevel gear 46, the upper end of the drive shaft 49 is provided with a drive sprocket 22, the drive sprocket 22 is provided with a chain 51, and the upper end of the drive shaft 49 is also provided with a turbine 24 located on the upper side of the drive sprocket 22. The right side of the driving cavity 48 is provided with a driven cavity 19, the left cavity wall of the driven cavity 19 is rotationally connected with a driven shaft 21 extending into the driving cavity 48, the left end of the driven shaft 21 is provided with a driving pulley 20, the driving pulley 20 is provided with a belt 18, the right end of the driven shaft 21 is provided with a second bevel gear 47 which is meshed and connected with the first bevel gear 46.

Advantageously, the cutting mechanism 73 includes a rotating rod 36 connected to the upper cavity wall of the cutting cavity 34, the upper end of the rotating rod 36 is provided with a sliding gear 53, the sliding gear 53 is provided with a sliding cavity 35 with an opening upward, the sliding cavity 35 is provided with a sliding gear 53 which can slide in the cavity, the upper end surface of the sliding block 52 is fixedly connected with a fixed rod 50, and the upper end of the fixed rod 50 is connected with the housing 1 0 outer wall is fixedly connected, the chain 51 is connected on the sliding gear 53, the lower end of the rotating rod 36 is provided with a third bevel gear 54, the left and right walls of the cutting cavity 34 are rotationally connected with a rotating shaft 37, the left end of the rotating shaft 37 is provided with a fourth bevel gear 55, and the right end of the rotating shaft 37 is provided with a cutting knife 38.

Advantageously, the conveying mechanism 70 includes a screw 13 rotating and connected to the left and right cavity walls of the conveying cavity 12, the left end of the screw 13 is provided with a driven pulley 17, the driven pulley 17 is connected with the belt 18, the left end of the screw 13 is also provided with a screw sleeve 15 located on the right side of the driven pulley 17, the upper side of the conveying cavity 12 is provided with a push cavity 44 with an opening to the right, and the screw sleeve 15 The upper end of the connecting block 16 is fixedly connected with a connecting block 16, the upper end of the connecting block 16 is provided with a push plate 14 located in the push cavity 44, the right cavity wall of the discharge port 43 is provided with a push block cavity 41 with an opening to the left, the push block cavity 41 is provided with a push block cavity 42 which can move left and right in the cavity, the right end of the push block cavity 42 is fixedly connected with a contraction spring 40, and the right end of the contraction spring 40 is connected with the right cavity wall of the push block cavity 41 Connect, the lower end of the contraction spring 40 is connected with the chain 63.

Advantageously, the cooling mechanism 74 includes a water pipe 39 located on the upper side of the push block chamber 41, the water pipe 39 is provided with a switch chamber 68, the switch chamber 68 is provided with a moving switch 67 for switching water source, the lower end face of the moving switch 67 is fixedly connected with an elastic spring 69, the lower end of the elastic spring 69 is connected with the lower chamber wall of the switch chamber 68, and the upper end face of the moving switch 67 is fixedly connected with an extension Ejector pin 66 into outer space.

Advantageously, the elastic force of the expansion spring 31 is larger than the sum of the weight of the lifting table 76 and the parts of the lifting table 76.

Advantageously, the elastic force of the return spring 61 is greater than the friction force received by the sliding of the moving gear 65 on the worm 75.

Advantageously, when the connecting block 16 pushes the steel to the rightmost side to stop moving, the driving pulley 20 will slip and stop rotating on the driven shaft 21.

Advantageously, pulling the chain 63 when the pushing block cavity 42 moves to the right enables the moving gear 65 to move to the right and mesh with the connecting gear 28.

Sequence of Mechanical Actions of the Whole Device

1: Manually open the feed baffle 57 and put the steel to be cut into the device;

2: Start the motor 45, drive the transmission shaft 49 to rotate, so as to drive the first bevel gear 46 on the transmission shaft 49 to rotate, so as to drive the second bevel gear 47 which is meshed with it to rotate, so as to drive the driven shaft 21 to rotate, so as to drive the driving pulley 20 on the driven shaft 21 to rotate, and the driving pulley 20 to rotate through the driven pulley 17 which is connected with the belt 18, so as to drive the screw 13 to rotate, so as to drive The threaded sleeve 15 and the connecting block 16 and the push plate 14 on the threaded sleeve 15 move to the right, thus pushing the steel to the right;

3: The rotation of the transmission shaft 49 drives the driving sprocket 22 on the transmission shaft 49 to rotate, so as to drive the sliding gear 53 connected by the chain 51 to rotate, so as to drive the rotating rod 36 to rotate, so as to drive the third bevel gear 54 on the rotating rod 36 to rotate, so as to drive the fourth bevel gear 55 connected with the third bevel gear 54 to rotate, so as to drive the rotating shaft 37 to rotate, so as to drive the cutter 38 on the rotating shaft 37 to rotate;

4: The transmission shaft 49 rotates, which drives the turbine 24 to rotate, so as to drive the worm 75 which is meshed with it to rotate, so as to drive the moving gear 65 on the worm 75 to rotate. When the steel moves to the right to push the pushing block chamber 42 to move to the right, the chain 63 at the lower end of the pushing block chamber 42 is tightened, so as to pull the moving gear 65 to move to the right to engage with the connecting gear 28, so as to drive the connecting gear 28 to rotate. So as to drive the rotating shaft 26 to rotate, so as to drive the rotating gear 32 on the rotating shaft 26 to rotate, so as to drive the meshing and connecting rack 33 to move downward, so as to drive the lifting platform 76 and the cutting knife 38 in the lifting platform 76 to move downward, and start cutting the steel. When the steel extrudes the pushing block cavity 42 to the maximum moving distance, the threaded sleeve 15 stops moving to the right, so as to make it active Pulley 20 slips on driven shaft 21 and stops rotating;

When the lifting platform 76 moves downward, the lower end face of the lifting platform 76 will squeeze the ejector pin 66, which will push the moving switch 67 to move downward, making the water pipe 39 connect and start spraying water, cooling the cutting process, and the cut steel falls into the discharge port 43. After cutting a section of steel, the pushing block chamber 42 moves to the left under the action of the shrinking spring 40, the chain 63 is loose, and the moving gear 65 is in the reset spring. The spring 61 moves to the left and disengages from the connecting gear 28, and the lifting table 76 moves upward under the action of the telescopic spring 31 to lift the cutter 38;

6. After cutting a complete piece of steel, start the motor 45 to reverse, so as to drive the screw 13 to reverse, so as to drive the connecting block 16 and the push plate 14 and the connecting block 16 on the threaded sleeve 15 to move to the left and reset to prepare for the next cutting.

The above embodiments are only to illustrate the technical concept and features of the invention, and the purpose is to enable people familiar with the technology in the field to understand the content of the invention and implement it, and not to limit the scope of protection of the invention. Any equivalent change or modification according to the spirit and substance of the invention shall be covered in the protection scope of the invention.

1. An automatic cooling and steel cutting equipment, comprising the utility model comprises a casing, which is characterized in that the right end of the casing is provided with a conveying cavity, a connecting cavity and a transmission cavity, the conveying cavity is provided with a conveying mechanism for pushing steel for cutting and an opening is upward, the connecting cavity is provided with a lifting mechanism for lifting the cutting part, the lower side of the connecting cavity is provided with a cutting mechanism for cutting steel, and the transmission cavity is provided with a driving mechanism for the device The right side of the conveying cavity is provided with a cooling mechanism to reduce the temperature when cutting steel;
The lifting mechanism comprises a worm which is rotationally connected with the right cavity wall of the transmission cavity and the left cavity wall of the connection cavity, the left end key of the right end of the worm is connected with a moving gear, the moving gear is provided with a moving cavity with an opening to the right, the moving cavity is provided with a moving block which can slide in the cavity, the right end surface of the moving block is connected with a chain, the left end of the worm is provided with a ring plate, and the right end surface of the moving block is connected with a chain. The right end face of the annular plate is fixedly connected with a return spring, the right end of the return spring is connected with the mobile gear, the left and right cavity walls at the upper end of the connection cavity are rotationally connected with a rotating shaft, the left end of the rotating shaft is provided with a connecting gear, the right end of the rotating shaft is provided with a rotating gear, the upper and lower cavity walls at the right end of the connection cavity are rotationally connected with a rack, and the upper end of the rack is provided with a stop outside the device Plate, the lower end of the baffle plate is provided with two expansion springs, the lower end of the expansion spring is connected with the upper end of the shell, the lower end of the rack is connected with a lifting platform outside the device, the lifting platform is provided with a cutting cavity, the lower end of the shell is provided with a discharging port for dropping the cut steel out of the device, the left end wall of the shell is provided with a feeding port for putting the steel to be cut into the device The left and right cavity walls of the feed inlet are rotationally connected with a fixed rod which is provided with a feed baffle plate;
the steel is pushed to the right through the conveying mechanism, and then it is lowered by the cutting mechanism through the lifting mechanism to cut the steel evenly. During the cutting process, the temperature at the time of cutting is lowered by the cooling mechanism, and finally the steel after cutting is automatically dropped into the discharge port.

2. The automatic cooling and steel cutting equipment as defined in claim 1, wherein The conveying mechanism includes an oil delivery hose, the left end of the oil delivery hose is fixed with a spiral block, the left side of the spiral block is provided with an oil outlet connected with the spiral block by thread, the oil outlet is provided with an oil outlet pump, the right end of the oil delivery hose runs through the oil outlet and the fixed block and is located in the collection cavity, and the right end of the oil delivery hose is also fixed with a restriction on the oil delivery hose the limiting plate which completely enters the collection cavity is fixed with two fixing plates on the left end face of the oil hose located in the external space, elastic rope is fixed between the two fixing plates, and two contact switches are fixed on the elastic rope.

3. The automatic cooling and steel cutting equipment as defined in claim 1, wherein the cutting mechanism comprises a rotating rod connected to the wall of the upper chamber of the cutting chamber, the upper end of the rotating rod is provided with a sliding gear, the sliding gear is provided with a sliding cavity with an opening upward, the sliding cavity is provided with a sliding gear which can slide in the cavity, the upper end of the sliding block is fixedly connected with a fixed rod, the upper end of the fixed rod is fixedly connected with the outer wall of the shell, and the sliding gear The chain is connected on the wheel, the lower end of the rotating rod is provided with a third bevel gear, the left and right cavity walls of the cutting cavity are rotationally connected with a rotating shaft, the left end of the rotating shaft is provided with a fourth bevel gear, and the right end of the rotating shaft is provided with a cutting knife.

4. The automatic cooling and steel cutting equipment as defined in claim 1, wherein The conveying mechanism includes rotating a screw rod connected to the left and right cavity walls of the conveying cavity, the left end of the screw rod is provided with a driven pulley, the driven pulley is connected with the belt, the left end of the screw rod is also provided with a threaded sleeve on the right side of the driven pulley, the upper side of the conveying cavity is provided with a pushing cavity with an opening to the right, the upper end of the threaded sleeve is fixedly connected with a connecting block, and the upper end of the threaded sleeve is fixedly connected with a connecting block. The upper end of the connecting block is provided with a push plate located in the push cavity, the right cavity wall of the discharge port is provided with a push block cavity with an opening to the left, the push block cavity is provided with a push block cavity which can move left and right in the cavity, the right end surface of the push block cavity is fixedly connected with a shrinkage spring, the right end of the shrinkage spring is connected with the right cavity wall of the push block cavity, and the lower end of the shrinkage spring is connected with a chain.

5. The automatic cooling and steel cutting equipment as defined in claim 1, wherein the cooling mechanism includes a water pipe on the upper side of the push block cavity, the water pipe is provided with a switch cavity, the switch cavity is provided with a moving switch for switching water source, the lower end face of the moving switch is fixedly connected with an elastic spring, the lower end of the elastic spring is connected with the lower cavity wall of the switch cavity, and the upper end face of the moving switch is fixedly connected with a top rod extending into the external space.

6. The automatic cooling and steel cutting equipment as defined in claim 1, wherein the elastic force of the expansion spring is greater than the sum of the weight of the lifting platform and the lifting platform components.

7. The automatic cooling and steel cutting equipment as defined in claim 1, wherein the spring force of the return spring is greater than the friction force received by the moving gear sliding on the worm.

8. The automatic cooling and steel cutting equipment as defined in claim 4, wherein when the connecting block pushes the steel to the rightmost side to stop moving, the driving pulley will slip and stop rotating on the driven shaft

9. The automatic cooling and steel cutting equipment as defined in claim 5, wherein when the pushing block cavity moves to the right, pulling the chain can make the moving gear move to the right and mesh with the connecting gear.
